(19) United States
(12) Patent Application Publication
(10) Pub. No.: US 2024/0295276 A1
(43) Pub. Date: Sep. 5, 2024

(54) VALVE

(71) Applicant: Justin C. Sitz, Bryan, TX (US)

(72) Inventor: Justin C. Sitz, Bryan, TX (US)

(21) Appl. No.: 18/595,373

(22) Filed: Mar. 4, 2024

Related U.S. Application Data
(60) Provisional application No. 63/487,884, filed on Mar. 2, 2023.

(51) Int. Cl. F16K 31/08; F16K 7/12; F16K 27/00; F16K 31/06; F16K 37/00

(52) U.S. Cl. CPC F16K 31/08; F16K 27/003

(57) ABSTRACT

Various aspects of the present disclosure relate to a valve device. The valve device includes an inlet, an outlet, a valve, and a magnetic flow control component that includes an actuator, a first magnet disposed on the actuator, and a second magnet disposed opposite the actuator. The actuator is actuatable, via the first and second magnets, to open and close the valve to allow or prevent fluid flow through the apparatus from the inlet to the outlet.

### FIELD

This invention relates to fluid flow control and more particularly relates to a valve for fluid flow control.

### BACKGROUND

Valves control fluid flow for a variety of applications, such as for irrigation, or for filling or topping up livestock tanks, ponds, pools, industrial fluid tanks, or the like. However, some valves may transition between an open state and a closed state at different rates, allowing a varying amount of fluid through the valve during the transition time period.

### SUMMARY

Various aspects of the present disclosure relate to a valve device. In one embodiment, an apparatus includes an inlet, an outlet, a valve, and a magnetic flow control component that includes an actuator, a first magnet disposed on the actuator, and a second magnet disposed opposite the actuator. In one embodiment, the actuator is actuatable, via the first and second magnets, to open and close the valve to allow or prevent fluid flow through the apparatus from the inlet to the outlet.

In one embodiment, the apparatus includes an adjustable flow control assembly for setting a flow rate of the fluid flow through the valve. In one embodiment, the apparatus includes an adjustable anti-freeze assembly for preventing fluid freezing in the valve.

In one embodiment, the apparatus is a manual control unit that allows manual interaction with the magnetic flow control component to allow or prevent fluid flow through the valve. In one embodiment, the magnetic flow control component is actuated in response to a magnetic object being presented to the manual control unit to magnetically act on the first magnet to actuate the actuator to open or close the valve using a magnetic force.

In one embodiment, the apparatus is an electric control unit comprising an electronic mechanism to allow or prevent fluid flow through the valve. In one embodiment, the magnetic flow control component is actuated in response to actuation of the electronic mechanism to position a third magnet to magnetically act on the first magnet to actuate the actuator to open or close the valve using a magnetic force.

In one embodiment, the apparatus is a temperature control unit that is actuated to allow or prevent fluid flow through the valve based on a temperature. In one embodiment, the temperature control unit comprises a bi-metal spring that is configured to position a third magnet in response to a change in the temperature to magnetically act on the first magnet to actuate the actuator to open or close the valve using a magnetic force.

In one embodiment, the apparatus is a leak detection control unit that controls fluid flow through the valve based on a volume of fluid collected from an external source. In one embodiment, the leak detection control unit comprises a separate container that is configured to hold the volume of fluid, the container comprising the magnetic flow control component and a magnetic float that comprises a third magnet that is configured to magnetically act on the first magnet based on the volume of the fluid within the container to actuate the actuator to open or close the valve using a magnetic force.

In one embodiment, the apparatus is a leak detection control unit that controls fluid flow through the valve based on contact with a fluid from an external source. In one embodiment, the leak detection control unit comprises a magnetic activation actuator comprising a third magnet that is configured to magnetically act on the first magnet to control the fluid flow through the valve using a magnetic force, the magnetic activation actuator triggered in response to contacting the fluid from the external source.

In one embodiment, the apparatus is a volume control unit that controls fluid flow through the valve based on a volume of fluid that has passed through the valve. In one embodiment, the volume control unit comprises an impeller that is configured to drive a third magnet of a magnetic control knob to a position to magnetically act on the first magnet to close the valve in response to an amount of fluid passing over the impeller satisfying the volume.

In one embodiment, the apparatus is a timing control unit that controls fluid flow through the valve based on an amount of time. In one embodiment, the timing control unit comprises a timing control valve and a container for holding a volume of fluid, the volume of fluid in the container controllable by the timing control valve, the container comprising a magnetic float that includes a third magnet that is configured to magnetically act on the first magnet based on the volume of fluid in the container to control the fluid flow through the valve using a magnetic force.

In one embodiment, the apparatus is a magnetic control unit that controls fluid flow through the valve based on magnetic interaction with an external third magnet, the external third magnet configured to magnetically act on the first magnet in response to being within magnetic proximity of the first magnet.

In one embodiment, the apparatus is a flow control unit that is configured to regulate a rate of fluid flow through the valve, the flow control unit comprising a flow control mechanism that can be set at one of a plurality of flow settings to control the rate of fluid flow through the valve. In one embodiment, the flow control unit comprises a magnetic activation switch comprising a third magnet, the magnetic activation switch actionable to move the third magnet to magnetically act on the first magnet to allow or prevent fluid flow through the valve.

In one embodiment, the apparatus is a modular control unit located between the inlet and the outlet and connecting the inlet to the outlet, the modular control unit controlling fluid flow through the valve from the inlet to the outlet using the magnetic flow control component, wherein the modular control unit is connectable to one or more additional modular control units to concurrently control the fluid flow from the inlet to the outlet.

In one embodiment, the inlet and the outlet comprise modular end plates that are removably connected to apparatus.

In one embodiment, a system for a valve device includes an inlet, an outlet, and a plurality of modular control units connected in series between the inlet and the outlet to concurrently control the fluid flow from the inlet to the outlet. In one embodiment, each of the plurality of modular control units comprises a valve and a magnetic flow control component that includes an actuator, a first magnet disposed on the actuator, and a second magnet disposed opposite the actuator. In one embodiment, the actuator is actuatable, via the first and second magnets, to open and close the valve to allow or prevent fluid flow through the apparatus from the inlet to the outlet.

In one embodiment, a method for a valve device includes providing an inlet, providing an outlet, providing at least one modular control unit comprising a valve and a magnetic flow control component that includes an actuator, a first magnet disposed on the actuator, and a second magnet disposed opposite the actuator. In one embodiment, the actuator is actuatable, via the first and second magnets, to open and close the valve to allow or prevent fluid flow through the apparatus from the inlet to the outlet. In one embodiment, the method includes connecting the at least one modular control unit to the inlet and the outlet, the at least one modular control unit controlling fluid flow through the valve from the inlet to the outlet using the magnetic flow control component, wherein the modular control unit is connectable to one or more additional modular control units to concurrently control the fluid flow from the inlet to the outlet.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a top perspective view illustrating one embodiment of a valve device;

FIG. 1B is a bottom perspective view illustrating another embodiment of a valve device;

FIG. 1C is a sectional view illustrating another embodiment of a valve device;

FIG. 1D is a top sectional view illustrating another embodiment of a valve device;

FIG. 2A is a side perspective view illustrating one embodiment of a valve device;

FIG. 2B is a side sectional view illustrating another embodiment of a valve device;

FIG. 2C is a side sectional view illustrating another embodiment of a valve device;

FIG. 3A is one embodiment of a perspective view of a valve device that includes a plurality of modular control units;

FIG. 3B is one embodiment of a top view of a valve device that includes a plurality of modular control units;

FIG. 3C is one embodiment of a front view of a valve device that includes a plurality of modular control units;

FIG. 3D is one embodiment of a bottom view of a valve device that includes a plurality of modular control units;

FIG. 3E is one embodiment of a right view of a valve device that includes a plurality of modular control units;

FIG. 3F is one embodiment of a left view of a valve device that includes a plurality of modular control units;

FIG. 3G is one embodiment of a top and sectional view of a valve device that includes a plurality of modular control units;

FIG. 3H is one embodiment of a top and sectional view of a valve device that includes a type of connected inlet and outlet endcaps;

FIG. 3I is one embodiment of a sectional view of a valve device that includes another type of connected inlet and outlet endcaps;

FIG. 3J is one embodiment of a sectional view of a valve device that includes another type of connected inlet and outlet endcaps;

FIG. 4A is one embodiment of a sectional view of a manual control unit;

FIG. 4B is one embodiment of another sectional view of a manual control unit;

FIG. 5A is one embodiment of a top and sectional view of a timing control unit;

FIG. 5B is one embodiment of another top and sectional view of a timing control unit;

FIG. 5C is one embodiment of another top and sectional view of a timing control unit;

FIG. 5D is one embodiment of another top and sectional view of a timing control unit;

FIG. 6A is one embodiment of a top and sectional view of a leak detection control unit;

FIG. 6B is one embodiment of another top and sectional view of a leak detection control unit;

FIG. 6C is one embodiment of another top and sectional view of a leak detection control unit;

FIG. 7A is one embodiment of a top and sectional view of a volume control unit;

FIG. 7B is one embodiment of another top and sectional view of a volume control unit;

FIG. 7C is one embodiment of another top and sectional view of a volume control unit;

FIG. 7D is one embodiment of another top and sectional view of a volume control unit;

FIG. 8A is one embodiment of a top view of a magnetic control unit;

FIG. 8B is one embodiment of a sectional view of a magnetic control unit;

FIG. 8C is one embodiment of another sectional view of a magnetic control unit;

FIG. 9A is one embodiment of a top and sectional view of an electric control unit;

FIG. 9B is one embodiment of another top and sectional view of an electric control unit;

FIG. 10A is one embodiment of a sectional view of a leak detection control unit;

FIG. 10B is one embodiment of another sectional view of a leak detection control unit;

FIG. 11A is one embodiment of a top and sectional view of a flow control unit;

FIG. 11B is one embodiment of another top and sectional view of a flow control unit;

FIG. 11C is one embodiment of another top and sectional view of a flow control unit;

FIG. 11D is one embodiment of another top and sectional view of a flow control unit;

FIG. 11E is one embodiment of another top and sectional view of a flow control unit;

FIG. 11F is one embodiment of another top and sectional view of a flow control unit;

FIG. 11G is one embodiment of a sectional view of a flow control unit;

FIG. 11H is one embodiment of another sectional view of a flow control unit;

FIG. 11I is one embodiment of another sectional view of a flow control unit;

FIG. 12A is one embodiment of a top and sectional view of a temperature control unit;

FIG. 12B is one embodiment of another top and sectional view of a temperature control unit;

FIG. 13 is a flow chart diagram illustrating one embodiment of a method for a valve.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

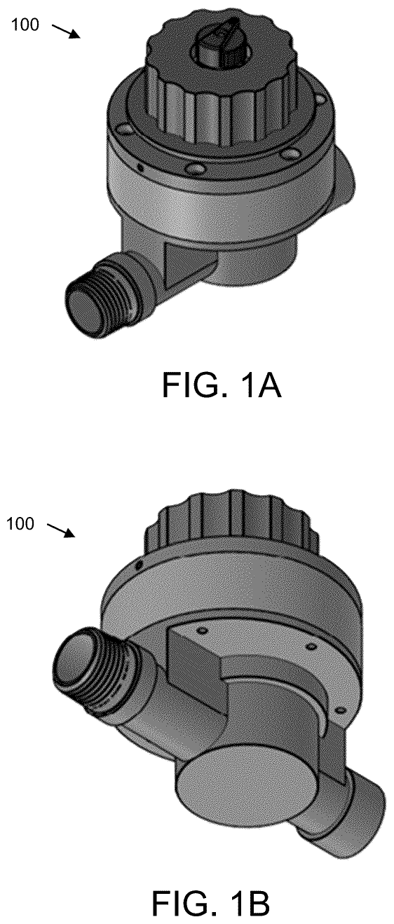

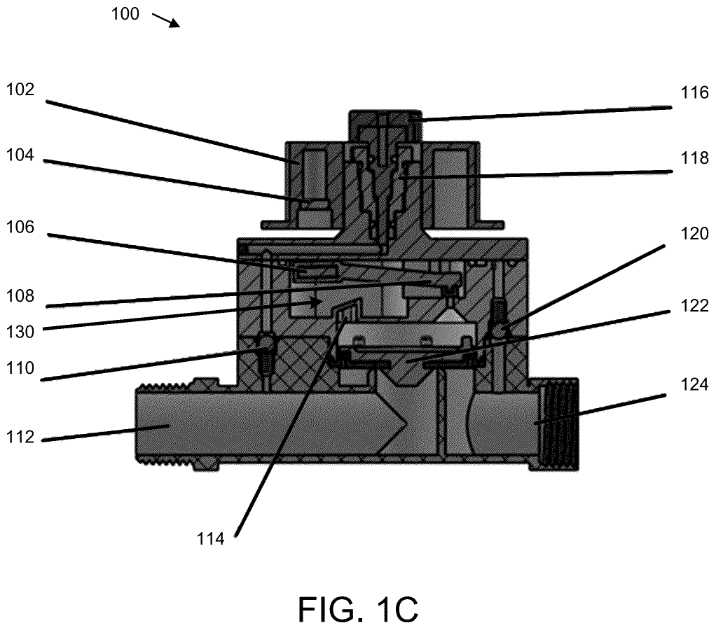

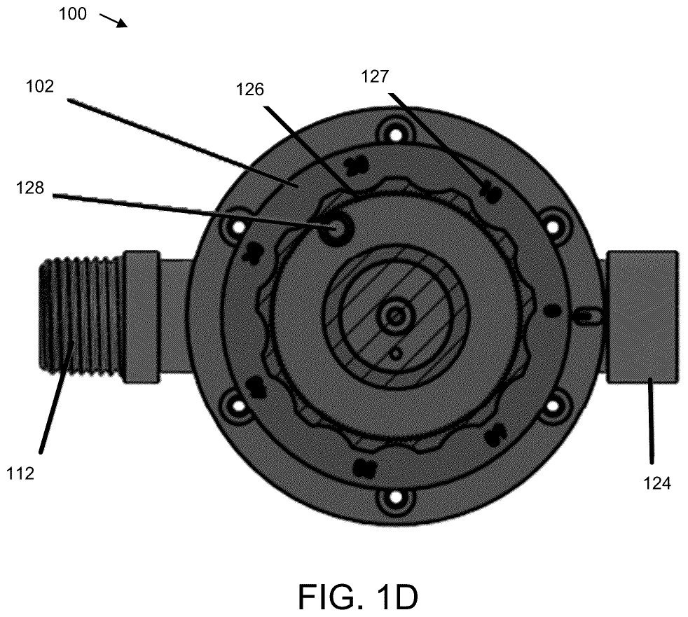

FIG. 1A depicts a top perspective view of one embodiment of a valve device 100 for flow control of a fluid or gas. FIG. 1B depicts a bottom perspective view of one embodiment of a valve device 100 for flow control of a fluid or gas. As described in more detail below, the valve device 100 may be used to regulate or adjust the flow of a fluid, e.g., water, or gas; may be turned on and off through use of a magnetic mechanism; may incorporate a timer to turn off automatically without the use of electricity; and may include a locking mechanism to prevent unauthorized use of the valve device 100, which is actuated using a custom, special, or otherwise specially designed key or tool. A fluid or gas flow controlled by the valve device 100, in various embodiments, may be the flow, movement, pressure, or current, of a fluid or gas through the valve device 100 (e.g., from the inlet 124 though the output 112).

As shown in FIG. 1C, which depicts a cutout view of the valve device 100, in one embodiment, the valve device 100 includes an activation knob 102 that may be actuated, rotated, or the like to activate/deactivate, turn on/turn off, or the like the valve device 100, to allow or prevent fluid flow through the valve device 100.

In further embodiments, the valve device 100 includes a magnet 104, which may be located in the activation knob 102 to be moved, positioned, or the like with actuation of the activation knob 102. In further embodiments, the valve device 100 includes a magnetic flow control component 130, mechanism, or the like. The magnetic flow control component 130 includes an actuator, e.g., a lever 108 that opposes a diaphragm 122 and is used to seal a port on the diaphragm cavity, which builds pressure forcing the diaphragm 122 to close and stop flow through the valve device 100.

In one embodiment, because the opening or closing of the valve is based on the pressure above the diaphragm 122, by relieving a small amount, the diaphragm 122 can open slightly to trigger a drip. In one embodiment, the valve device 100 may include a passage that leads from the diaphragm chamber to the outlet 112. In such an embodiment, the passage is initially blocked by a rubber ball. Pressure may be applied to the rubber ball by a small rod, which is encased in a sleeve filled with a temperature sensitive material, e.g., a material that expands and contracts with temperate changes such as thermal wax. Upon detecting freezing temperatures (e.g., 32 degrees F. or lower), the temperature sensitive material shrinks, relieving pressure on the rubber ball, which allows fluid to exit from above the diaphragm 122 and activates the valve. A set screw may be included that allows the user to deactivate this feature by applying pressure and pushing the assembly towards the rubber ball, overcoming the travel of the rod from the temperature sensitive material shrinkage during cold temperatures.

In one embodiment, the magnetic flow control component 130 includes a filter to keep debris, particulates, and/or other materials out of the magnetic flow control component 130. For example the port on the diaphragm cavity may include a filter to prevent clogging and to keep the port free from contaminates and debris.

In one embodiment, the lever 108 includes a lever magnet 106 that closes the diaphragm port when the activation knob 102 is rotated into position to align the magnet 104 in the activation knob 102 with the lever magnet 106 in the lever 108. Other types of valve components may be included such as a plunger, a ball, or the like and may turn a fluid or gas flow on or off based on the position of the movable component.

In one embodiment, the valve device 100 includes a bias magnet 114 within the magnetic flow control component 130 that is used to attract the lever magnet 106 in the lever 108 when the magnet 104 within the activation knob 102 is positioned or rotated away from the lever magnet 106 in the lever 108, e.g., to bias the lever 108 towards the bias magnet 114 within the magnetic flow control component 130. In such an embodiment, when the lever magnet 106 in the lever 108 is aligned with the bias magnet 114 within the magnetic flow control component 130, disposing the lever 108 in a down position, the diaphragm port is opened to allow fluid or gas flow through the valve device 100.

In one embodiment, the bias magnet 114 within the magnetic flow control component 130 is offset from the lever magnet 106 within the lever 108, is weaker than the magnet 104 in the activation knob 102, and/or the like so that the attraction between the magnet 104 in the activation knob 102 and the lever magnet 106 in the lever 108 is greater or stronger than the attraction between the bias magnet 114 in the magnetic flow control component 130 and the lever magnet 106 in the lever 108. Alternatively, in another embodiment, the valve may be constantly on with the lever magnet 106 repelling the bias magnet 114 and the magnet 104 in the activation knob 102 being strong enough to repel the lever magnet 106 downward despite the repelling force of the bias magnet 114.

In one embodiment, the valve device 100 includes an adjustable flow control knob 116 that acts on an adjustment valve when actuated to adjust the flow of fluid or gas through the valve device 100. In one embodiment, the adjustable flow control knob 116 and the adjustment valve knob 116 can be removed for cleaning or other maintenance purposes. In one embodiment, the adjustment valve knob 116 is located within an adjustment valve housing 118. In one embodiment, the adjustable flow control knob 116 is an independent knob that, when set, holds that position/flow control setting regardless of the on/off position of the activation knob 102.

In one embodiment, the valve device 100 includes a plurality of check valves. For instance, the valve device 100 may include a check valve 110 for fluid or gas output and a check valve 120 for fluid or gas input, e.g., to prevent backflow. In such an embodiment, the check valve 120 for fluid or gas input may be directed to the diaphragm to close the inlet and outlet. In such an embodiment, the passage to the diaphragm at the check valve 120 may include a filter to prevent debris and other materials from entering the diaphragm.

In one embodiment, the valve device 100 includes an inlet 124, where fluid or gas enters the valve device 100, and an outlet 112, where fluid or gas leaves the valve device 100. In the depicted embodiment, the valve device 100 controls a fluid/gas flow through the valve device 100, from an inlet 124 through the output line 112. The inlet 124, in the depicted embodiment, is configured to connect to a hose, pipe, or other threaded connector so that the valve device 100 controls a flow of liquid/fluid or gas. In another embodiment, an inlet 124 may be a fitting or connection that couples the valve device 100 to a fluid or gas source such as a storage tank, a pipe, or the like. Controlling a fluid/gas flow may include permitting or turning on a fluid/gas flow (e.g., when the valve device 100 opens), and/or blocking or turning off a fluid/gas flow (e.g., when the valve device 100 closes). In some embodiments, controlling a fluid/gas flow may include permitting a limited or restricted fluid/gas flow.

FIG. 1D depicts a cutout of a top view perspective of one embodiment of a valve device 100. In one embodiment, the activation knob 102 includes internal splines or teeth 126 that align with a drive mechanism 128. In one embodiment, the activation knob 102 includes volume or time indicator markings 127 that indicate how long the valve device 100 will be on, e.g., 10 minutes, 20 minutes, or the like (which may be based on a volume of fluid flow), such that when the activation knob 102 is actuated for an amount of time or volume flow that corresponds to the volume or time indicator markings 127, the valve device 100 will allow fluid or gas to flow for the indicated amount of time/volume.

In one embodiment, the drive mechanism 128 is configured to return the activation knob 102 back to a starting position (e.g., time 0), by acting against the internal splines 126, which aligns the magnet 104 within the activation knob 102 with the magnet 106 in the lever 108 to close the diaphragm 122 and turn the valve device 100 off (preventing flow of fluid or gas through the valve device 100 from the inlet 124 to the outlet 112). In one embodiment, the drive mechanism 128 is powered by a mainspring; however, the drive mechanism 128 could be powered by the flow of fluid or gas through the valve device 100, or the like. Such an embodiment allows the valve device 100 to measure the amount (volume) of fluid/gas that passes or goes through the valve device 100 and shut off when a threshold amount of fluid/gas is satisfied, as opposed to or in addition to, deactivating after a specified period of time.

In one embodiment, the valve device 100 can be turned off or deactivated in several ways. In some embodiments, the valve device 100 can be manually deactivated, e.g., by manually adjusting or rotating the activation know 102 to an off state, or by another mechanical means. In certain embodiments, the valve device 100 is deactivated in response to expiration of a timer, e.g., in response to the activation knob 102 reaching time 0.

In one embodiment, the valve device 100 is deactivated in response to a threshold amount of fluid or gas passing through the valve device 100. In such an embodiment, the amount of fluid/gas that passes through the valve device 100 could be measured using internal impellers that speed up or slow down the advancement of the activation knob 102 and the magnet 104 into the off position (described in more detail below). In certain implementations where the pressure of the fluid or gas is below a threshold (e.g., is low), the amount of time that the valve device 100 is open could be less important than the amount or volume of fluid or gas that has passed through the valve device 100.

In one embodiment, using a magnetic flow control component 130 as described herein replaces many of the standard seals that can be prone to failure. Further, the magnetic flow control component 130 allows activation of the valve with minimal rotational effort as opposed to conventional valves requiring multiple rotations. For instance, conventional valves set their on/off and flow control settings with the main knob, whereas the valve device 100 described herein has two independent knobs. Accordingly, when a known flow setting is needed, the flow setting can be set through the flow control device, from here activation is a short rotation to bring the valve device 100 back to the same flow control rate each time it is activated.

Furthermore, additional consistency can be achieved each time the valve device 100 is activated as it doesn't require a user to try and hit a set number of rotations, as opposed to a conventional knob. Here, the magnets are applying the pressure to close the valve (helped through leverage), which eases the amount of pressure a user puts on a rotational knob. For example, if the pressure to fully shut off a water hose is “X”, then the pressure to shut the valve device 100 off will be a fraction of “X”. Should a user have a disability or any medical condition hindering their hand strength/dexterity, this valve device 100 would be easy to turn on and off.

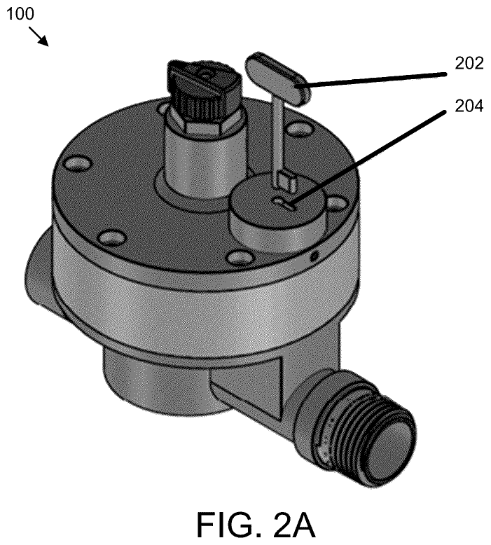

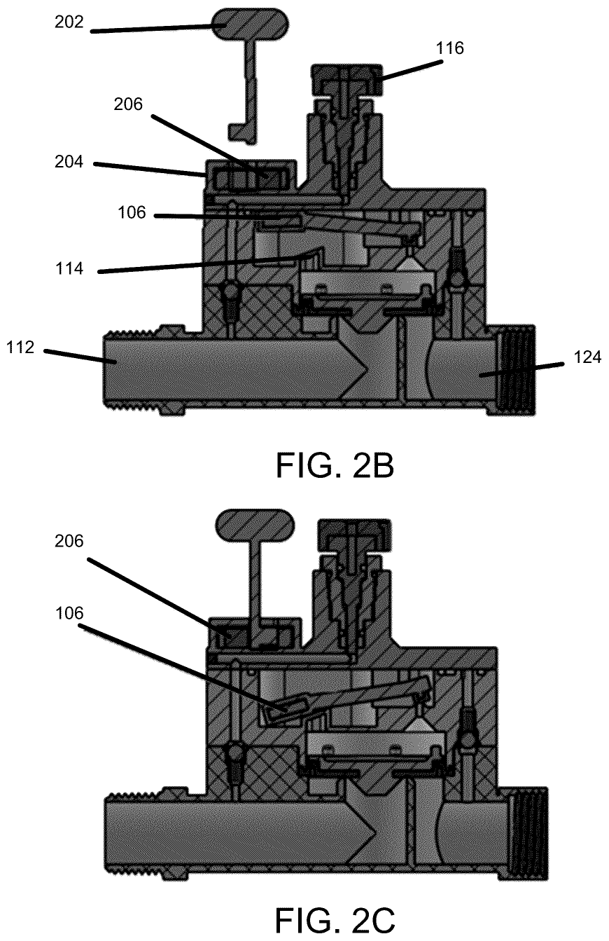

FIG. 2A depicts an embodiment of a valve device 100 that includes a locking mechanism for preventing unauthorized use of the valve device 100. In one embodiment, a key 202, tool, or other mechanism is used to turn the valve device 100 on or off. The key 202, for example, is inserted into a housing 204 that contains the locking mechanism to activate or deactivate fluid flow through the valve device 100.

As shown in FIGS. 2B and 2C the locking mechanism may include a magnet 206 that is actuated by turning or actuating the key 202, when inserted into the housing 204. In one embodiment, shown in FIG. 2B, the valve device 100 is in an inactive or off state with the magnet 206 within the locking mechanism aligning with and attracting the magnet 106 within the lever 108, which closes the diaphragm port and builds pressure in the diaphragm cavity, consequently closing the valve device 100.

In FIG. 2C, the key 202 is inserted into the locking mechanism and actuated to move, rotate, or otherwise position the magnet 206 out of alignment or attracting position with the magnet 106 within the lever 108, which allows the lever 108 to pivot away and open the diaphragm port. This activates the valve device 100 to allow fluid or gas to flow through the valve device 100 from the inlet 124 to the outlet 112. In one embodiment, during fluid or gas flow, the adjustable flow knob 116 can be adjusted to control the flow rate of the fluid or gas.

In one embodiment, the valve device 100 described herein does not include traditional rubber seals, which can be prone to leaks such as traditional hose bib washers. In one embodiment, the valve device 100 requires significantly less force to the valve on or off, prevents overwatering (e.g., due to not turning the valve off), and prevents unauthorized use of the valve device 100. In one embodiment, the valve device 100 includes a diaphragm valve that is adjustable and an adjustable flow assembly valve that is easy to remove and clean/maintain.

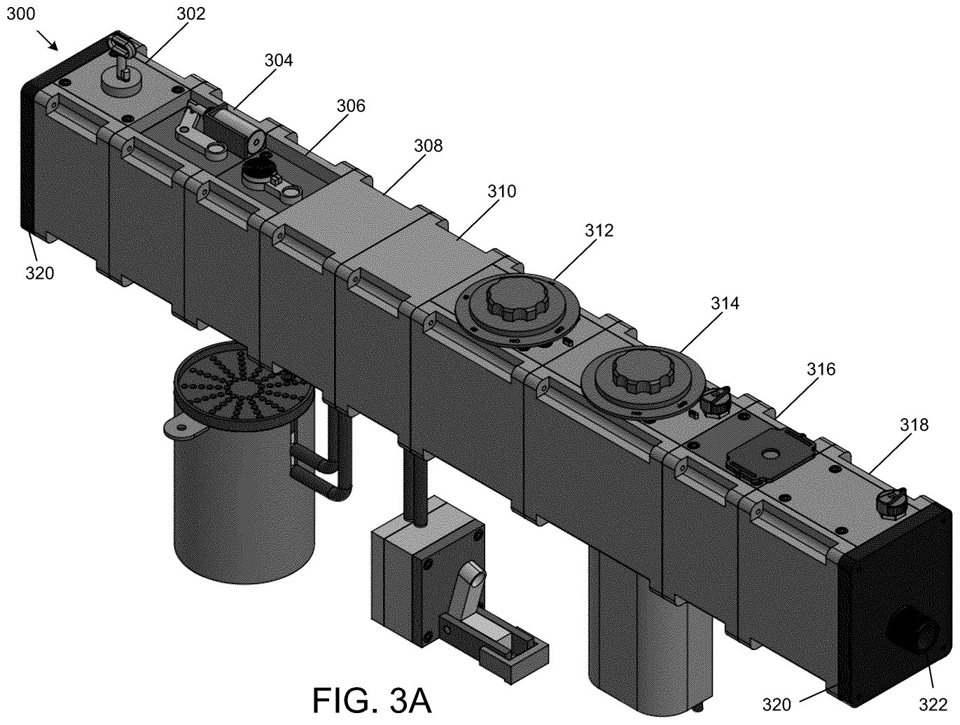

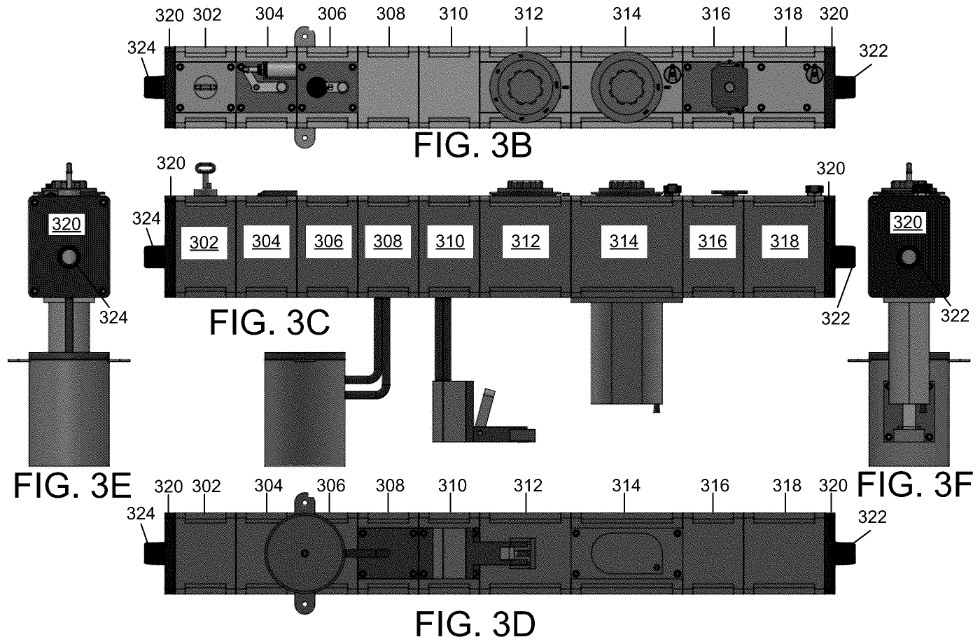

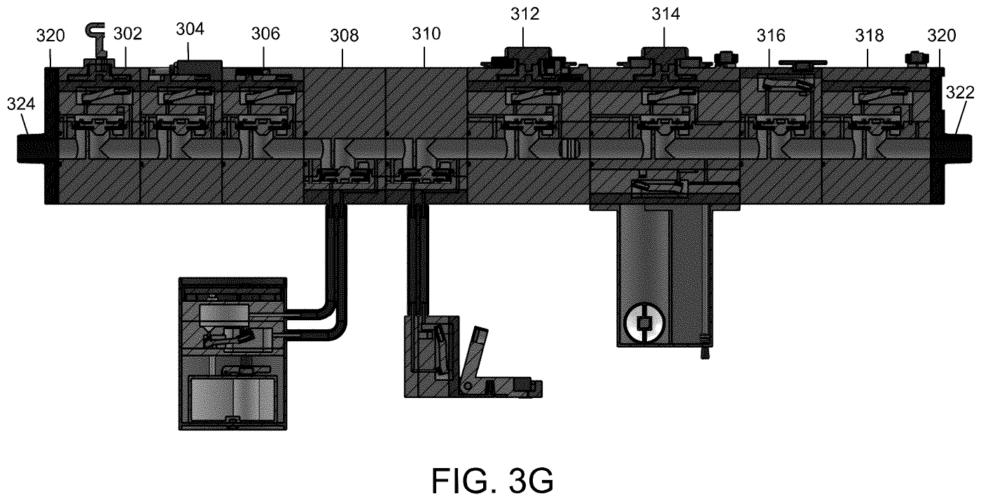

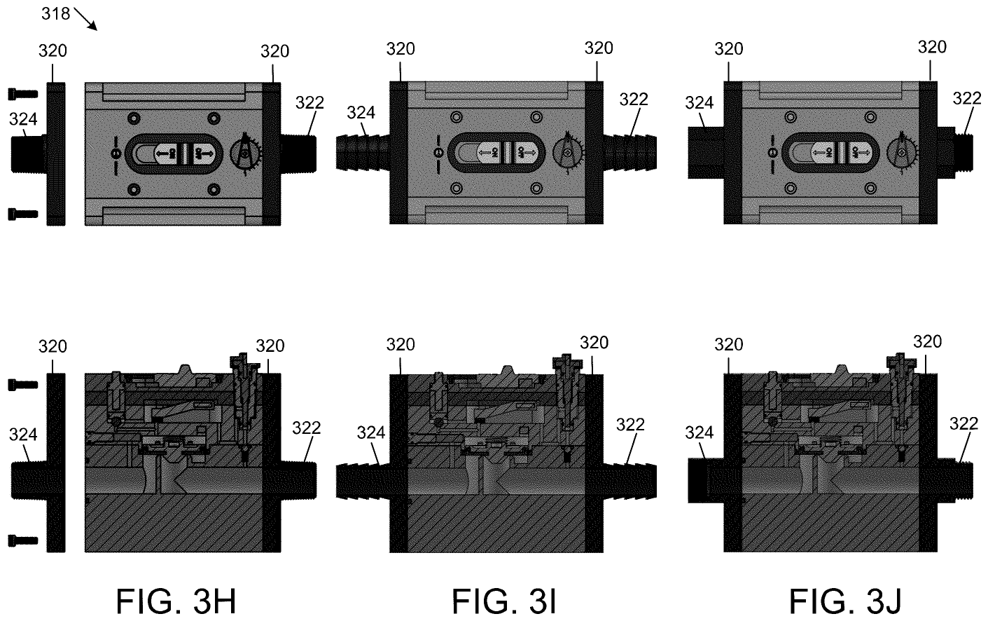

FIG. 3A depicts one embodiment of a perspective view of a valve device 300 that is comprised of an inlet 324 (shown in FIGS. 3B-3D, an outlet 322, and various modular control units 302-318 located between the inlet 324 and the outlet 322. The modular control units 302-318 may be positioned between endcaps 320. In one embodiment, the modular control units 302-318 are connected, fastened, or the like to one another, e.g., in series and are configured to concurrently control a flow of fluid through the valve device 300, e.g., from the inlet 324 through each of the modular control units 302-318 and out the outlet 322, based on different settings, factors, conditions, and/or the like, as described in more detail below.

FIG. 3B depicts an example embodiment of a top view of the valve device 300. FIG. 3C depicts one embodiment of a side view of the valve device 300. FIG. 3D depicts one embodiment of a bottom view of the valve device 300. FIGS. 3E and 3F depicts embodiments of left and right views of the valve device 300, respectively. FIG. 3G depicts an embodiment of a sectional view of the valve device 300.

In one embodiment, even though a specific number and type of modular control unit 302-318 are shown in FIGS. 3A-3F, the valve device 300 could include any number, any type, multiple types, any combination of types, or the like of the modular control units 302-318. In certain embodiments, the modular control units 302-318 are connected to one another by fasteners (e.g., screws, pins, or the like), adhesives, a friction fit, a screw fit, and/or the like.

In one embodiment, FIGS. 3H-3J shows various different inlet 324 and outlet 322 connections that may be used as endcaps 320 for a modular control unit (here a flow control unit 318). In one embodiment, as shown in FIG. 3H, the inlet 324 and outlet 322 may each include threaded connectors. FIG. 3I shows an inlet 324 and an outlet 322 that include barbed connectors. FIG. 3J shows an inlet 324 connector that is a female threaded connector and an outlet 322 that is a male threaded connector. FIGS. 3H-3J show a few examples of different connector types for the inlet 324 and outlet 322; however, one of skill in the art may recognize, in light of this disclosure, various other connector types that may be used.

In one embodiment, the modular control units 302-318 include a manual control unit 302, an electric control unit 304, a temperature control unit 306, a leak detection control unit 308, 310, a volume control unit 312, a timing control unit 314, a magnetic control unit 316, and a flow control unit 318, which are described in more detail below.

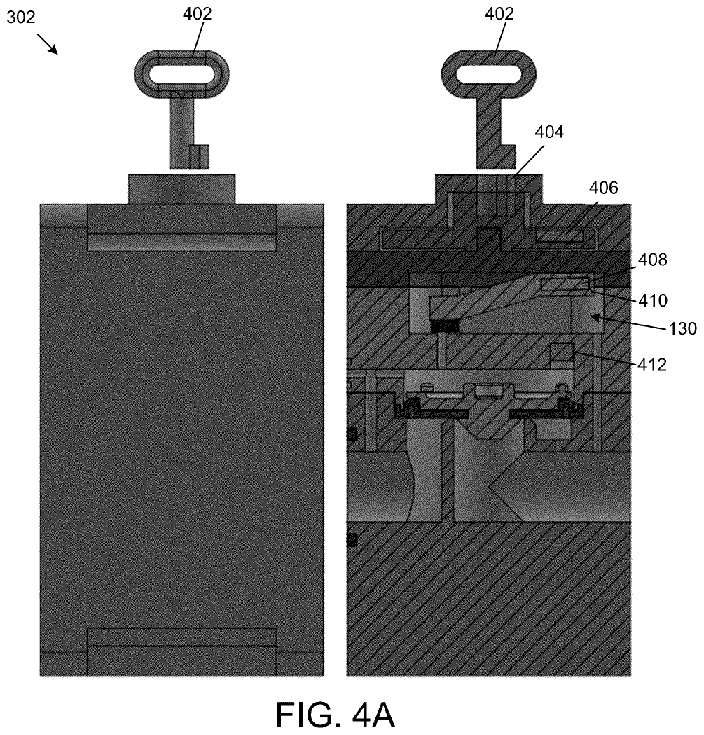

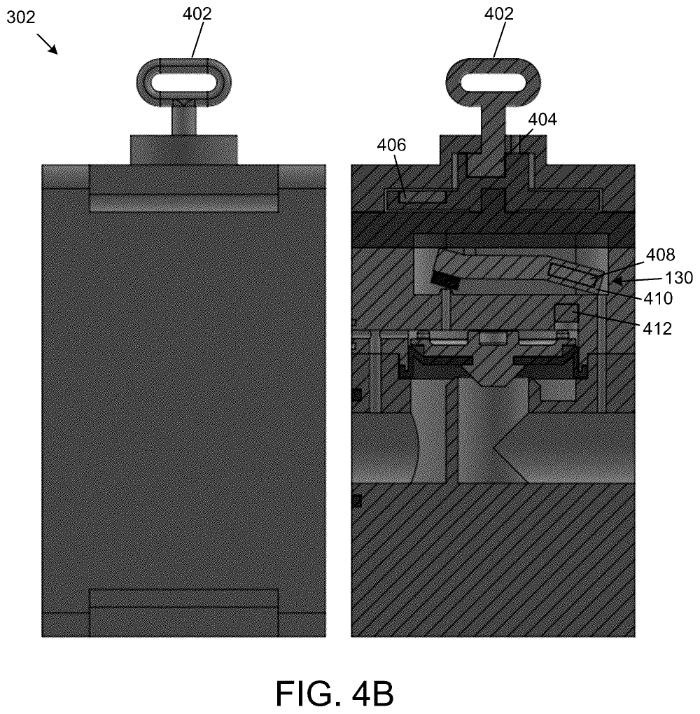

In one embodiment, FIGS. 4A-4B depict one embodiment of a manual control unit 302. In one embodiment, the manual control unit 302 is configured to allow or prevent fluid flow through the valve device 300 (e.g., as described above with reference to FIGS. 1A-D), and in particular, through a valve that is controlled by a magnetic flow control component 130, which includes a lever 410, a lever magnet 408, and a bias magnet 412.

In one embodiment, the manual control unit 302 prevents fluid flow through the manual control unit 302 when the lever 410 is in the up position, through magnetic attraction between the lever magnet 408 and a corresponding external magnet 406 that is external to the magnetic flow control component 130, e.g., in a lid, cover, surface, or the like, of the manual control unit 302.

In one embodiment, an item such as a key 402 may be inserted into a slot 404, opening, or other actuation point on the manual control unit 302 to move, rotate, position or otherwise displace the external magnet 406. As shown in FIG. 4B, rotating the key 402 moves the external magnet 406 away from the lever magnet 408, breaking the magnetic attraction, which causes the lever 410 to move down and towards the bias magnet 412, e.g., due to magnetic attraction between the lever magnet 408 and the bias magnet 412. When the lever 410 is moved to the down position, the valve is opened and fluid is allowed to flow through the manual control unit 302, e.g., the lever 410 opens the diaphragm port, which allows fluid to flow from the inlet to the outlet through the manual control unit 302 (e.g., as described above with reference to FIGS. 1A-D).

In an alternative embodiment, the lever 410 may be pushed up, closing the valve, due to magnetic repelling force between the lever magnet 408 and the bias magnet 412 (e.g., in a default or constant on position) and the key 402 may be used to rotate the external magnet 406 to a position above the lever magnet 408 and repel the lever magnet 408 away to move the lever 410 to the down position, opening the valve, and allow fluid flow through the manual control unit 302 (e.g., as described above with reference to FIGS. 1A-D).

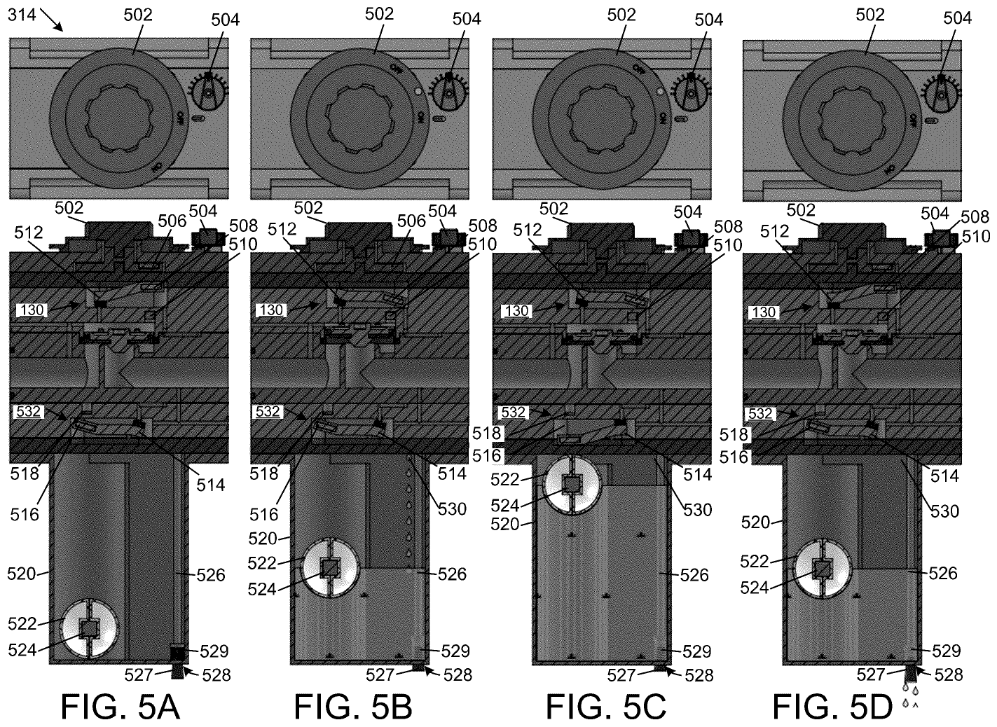

FIGS. 5A-5D show one embodiment of various stages of the timing control unit 314. In one embodiment, the timing control unit 314 includes an activation control/knob 502 and a timing control/knob 504. The activation knob 502 can be rotated or positioned to turn the timing control unit 314 on and off. In one embodiment, when the timing control unit 314 is off, an activation magnet 506 on the activation knob 502 (e.g., on an underside or embedded within the activation knob 502) is positioned inline or proximate to the lever magnet 508 in the lever 512 within the magnetic flow control component 130 of the timing control unit 314, which magnetically attracts the lever magnet 509 and holds the lever 512 in the up position to close the valve and prevent fluid flow through the timing control unit 314 (e.g., as described above with reference to FIGS. 1A-D)

In one embodiment, when the activation knob 502 is positioned in the on position, the activation magnet 506 is rotated away from the lever magnet 508, the lever 512 is biased downward, e.g., either by gravity, leverage, or a bias magnet 510, which opens the valve and allows fluid to flow through the timing control unit 314 (e.g., as described above with reference to FIGS. 1A-D).

In one embodiment, the timing control unit 314 includes a second magnetic flow control component 532 and a container 520 that includes a magnetic float 522 and a shaft 526. In certain embodiments, the second magnetic flow control component 532, container 520, magnetic float 522, and shaft 526 are configured to control how long fluid is allowed to flow through the timing control unit 314 while the activation knob 502 is in the on position. In other words, even if the activation knob 502 is placed in the on position, the timing control unit 314 includes a timing mechanism that allows fluid flow for a set period of time and may prevent fluid from flowing perpetually through the timing control unit 314.

FIGS. 5A-5D illustrate an example progression of different states of the timing control unit 314 from an initial off state, to an on state, and back to an off state. In one embodiment, shown in FIG. 5A, when the activation knob 502 is in an off position, the valve is closed to prevent fluid flow through the timing control unit 314 and no fluid enters the container 520. Also, the shaft 526 is positioned such that the drain port 528 is open. In one embodiment, the activation knob 502 is mechanically connected to the shaft 526 to move the shaft 526 up and down, closing and opening the drain port 528, in response to the activation knob 528 being rotated between on and off positions, respectively.

In FIG. 5B, the activation knob 502 is rotated to the on position, which opens the valve and allows fluid to flow through the timing control unit 314. In one embodiment, as fluid flows through the timing control unit 314, a portion of the fluid is redirected to the container 520 via a fill port 530. In one embodiment, the timing knob 504 controls the rate at which fluid is redirected from the fluid flow, e.g., from the chamber, the outlet line, or the like, and into the container 520. In such an embodiment, the timing knob 504 may be actuated/rotated to a position to adjust the rate at which fluid is redirected to the fill port 530 to the fill port 530. In one embodiment, the timing knob 504 is removable from the timing control unit 314 to allow for cleaning, maintenance, repair, or the like.

Continuing with FIG. 5B, when the activation knob 502 is rotated to the on position, the shaft is moved (e.g., raised) to plug the drain port 528 and prevent fluid from exiting the container 520 through the drain port 528. In such an embodiment, the shaft 526 may include a plug 527, e.g., a rubber plug or other malleable plug and a spring 529 that allows the shaft to plug and open the drain port 528. As fluid fills the container 520, the magnetic float 522 raises with the fluid level. In one embodiment, the float 522 is round to prevent drag, e.g., if the timing control unit 314 is placed on an angle.

As shown in FIG. 5C, as the container 520 continues to fill with fluid, the float 522 may reach a level where the float magnet 524 magnetically interacts with, e.g., magnetically attracts, a lever magnet 516 in a lever 514 of the second magnetic flow control component 532, which causes the valve to close to prevent fluid flow through the timing control unit 314 (e.g., as described above with reference to FIGS. 1A-D). In other words, the second magnetic flow control component 532 is mechanically connected to the fluid flow, e.g., the output line, through the timing control unit 314 to allow and prevent fluid flow through the timing control unit 314. Thus, even though the activation knob 502 is in the on position, allowing fluid flow according to the magnetic flow control component 130, the second magnetic flow control component 532 prevents the fluid flow after a period of time, which is determined according to the fluid fill rate of the container 520, as set by the timing knob 504.

In FIG. 5D, the activation knob 502 is rotated back to the off position. In such an embodiment, the activation magnet 506 is positioned in magnetic attraction with the lever magnet 508, which raises the lever 512 to the up position to close the valve (e.g., as described above with reference to FIGS. 1A-D). In one embodiment, when the activation knob 502 is moved to the off position, the shaft 526 is moved downward to open the drain port 528 and allow fluid to exit the container 520. As fluid exits the container 520, the float moves away from the lever magnet 516 in the lever 514 of the second magnetic flow control component 532, and the lever 514 is biased to an open position by magnetic attraction between the lever magnet 516 and the bias magnet 518.

In this manner, by using a variable drip control mechanism, e.g., the timing knob 504, the user can set a time for the timing control unit 314 to run regardless of the flow. In the event a user forgets to turn the timing control unit 314 off, such as in a watering situation with a garden hose, once enough time has passed, the container 520 will fill raising the float 522 and rendering the valve closed. Once the user recognizes the error and returns the activation knob 502 to the off position, the container will be depleted at which time the activation knob 502 can be returned to the on position and restart operations. Each time the activation knob 502 goes to the off position, the container 520 is depleted of fluid it has gained and is reset. In a garden situation, it would be a few ounces of water that would be relieved from the container 520, which may be of little concern hitting the ground. In an industrial application, the fluid from the container 520 could be directed to a drain or in the case of toxic fluids to a designated holding reservoir.

In one embodiment, a containers 520 and a second magnetic flow control component 532 may be encased as a separate component that is remotely connected to the valve. In such an embodiment, multiple containers may be inter-connected, e.g., in series, to form a circuit, such that when one of the containers fills up and turns off the second magnetic flow control component 532, the entire circuit is disabled. This configuration may act as a fluid control safety shutoff if the valve/fluid was left unattended and ran longer than it needed to. In this manner, the rate at which fluid fills the container controls how long the fluid is allowed to flow, e.g., how long the valve is open, before it shuts itself off.

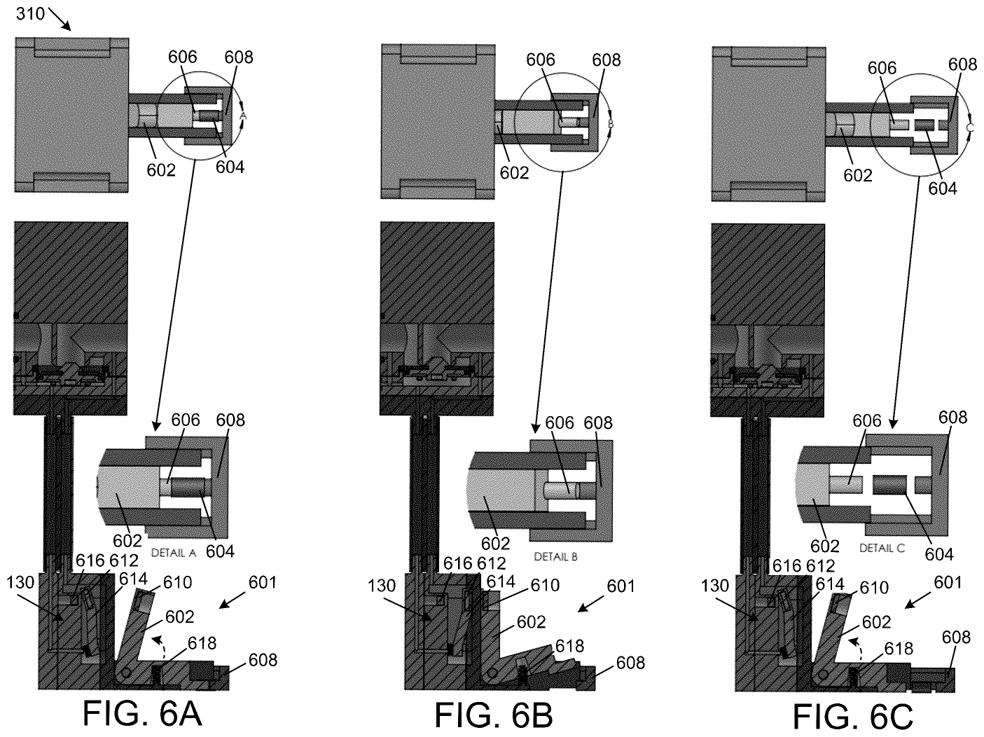

FIGS. 6A-6C show one embodiment of various stages of a leak detection control unit 310. In one embodiment, the leak detection control unit 310 is configured to turn off a fluid flow through the valve device 300 in response detection of a fluid that is external to the leak detection control unit 310.

In one embodiment, the leak detection control unit 310 comprises a base portion 601 that includes an activation lever 602. In one embodiment, the base portion 601 is placed in an area that may be exposed to water, e.g., on the ground, in a wall, and/or the like. In one embodiment, the activation lever 602 is biased by a spring 618 (or a magnet or other mechanical force) towards a magnetic flow control component 130, which includes a lever 614 that controls fluid flow through the leak detection control unit 310 by mechanically opening and closing a valve within the leak detection control unit 310.

As shown in FIG. 6A, in one embodiment, the activation lever 602 may be set in place, loaded, or the like using a pin, peg, or other protrusion 606 connected to the activation lever 602. A separate set pin, peg, or protruding member 608 may be removably connected to the base 601 opposite the protrusion 606 on the activation lever 602. The protrusion 606 on the activation lever 602 and the separate protruding member 608 may be selectively connected by a water-soluble or dissolvable material 604, e.g., a tube, fitting, or the like that is made of a material that dissolves when in contact with a liquid.

As shown in FIG. 6B, in one embodiment, when liquid contacts the dissolvable material 604, the activation lever 602 is released or triggered and biased towards the magnetic flow control component 130 by the spring 618. Consequently, the magnet 610 in the activation lever 602 magnetically attracts the lever magnet 612, which disposes or positions the lever 614 towards the activation lever 602 and closes the valve, shutting off fluid flow through the leak detection control unit 310 (e.g., as described above with reference to FIGS. 1A-D).

As shown in FIG. 6C, to reset the activation lever 602, the protruding member 606 on the activation lever 602 is connected to the protruding member 608 with a dissolvable material 604, e.g., a tube, fitting, or other connector that is dissolvable in a fluid. In such an embodiment, when the magnetic force is broken between the magnet 610 in the activation lever 602 and the lever magnet 612, the lever 614 is moved or biased towards a bias magnet 616 within the magnetic flow control component 130, which opens the valve and allows fluid to flow through the leak detection control unit 310 (e.g., as described above with reference to FIGS. 1A-D).

In one embodiment, the magnetic flow control component 130 and the base 601 may be located at any distance from the valve portion of the leak detection control unit 310 by extending the fluid lines, hoses, tubes, or the like between the valve portion and the magnetic flow control component 130.

In an alternate embodiment, the activation lever 602 may be biased away from the magnetic flow control component 130 and a water-absorbing material may be used to expand and push or force the activation lever 602 towards the magnetic flow control component 130 when in contact with a fluid such as water.

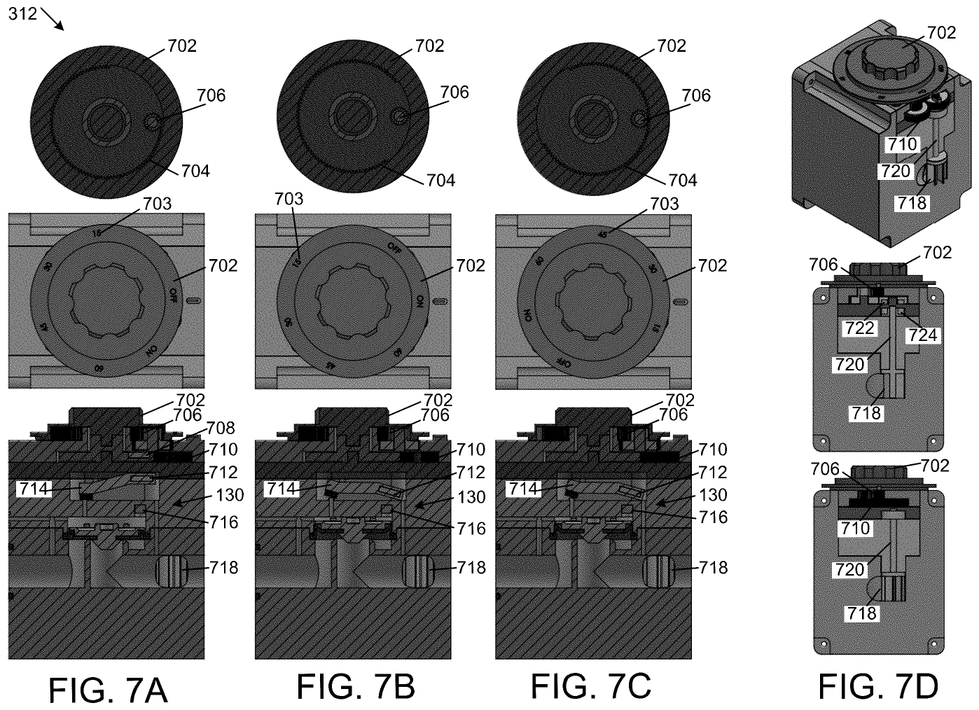

FIGS. 7A-7C show one embodiment of various stages of a volume control unit 312. In one embodiment, the volume control unit 312 includes an activation knob 702 that includes a plurality of teeth 704, splines, or the like on in a radial configuration on the underside of the activation knob 702. In one embodiment, the activation knob 702 is actuated, e.g., rotated or turned, to turn the volume control unit 312 on, off, or to set the amount of fluid that flows through the volume control unit 312 before it is turned off. Accordingly, on a top-side of the activation knob 702 are markings 703 to indicate where to turn the activation knob 702 to activate or deactivate the volume control unit 312.

As shown in FIG. 7A, in one embodiment, with the activation knob 702 in the off position, a magnet 708 in the activation knob 702 (or coupled to the activation knob 702) is positioned above a lever magnet 712 in a lever 714 of a magnetic flow control component 130 to dispose the lever 714 in an up position to close the valve and prevent fluid flow through the volume control unit 312 (e.g., as described above with reference to FIGS. 1A-D).

As shown in FIG. 7B, when the activation knob 702 is rotated to the on position, the magnet 708 in the activation knob 702 (or coupled to the activation knob 702) is positioned away from the lever magnet 712 in the lever 714 of the magnetic flow control component 130, which causes the lever 714 to be disposed in a downward direction by magnetic attraction between the bias magnet 716 and the lever magnet 712, which opens the valve and allows fluid flow through the volume control unit 312 (e.g., as described above with reference to FIGS. 1A-D). In such an embodiment, when the activation knob 702 is rotated to the on position, the lever 714 stays in the down position, which allows fluid flow through the volume control unit 312 indefinitely.

As shown in FIG. 7C, when the activation knob 702 is rotated to a volume control setting indicated by one of the markings 703, the teeth 704 on the underside of the activation knob 702 engage with an activation gear 706 that is used to drive the activation knob to the off position after the set volume of fluid has passed through the volume control unit 312. In one embodiment, the volume control unit 312 includes an impeller 718 that rotates as fluid flows through the volume control unit 312. As used herein, an impeller 718 may refer to a component that rotates as fluid flows past the impeller's vanes, fins, or the like.

In one embodiment, shown in FIG. 7D, the impeller 718 is connected to a shaft 720, which is connected to shaft magnets 724. In one embodiment, the shaft magnets 724 are magnetically connected to a drive magnet 722 in the drive gear 710. As the impeller 718 rotates, in one embodiment, the shaft 720 causes the shaft magnets 724 to rotate, which magnetically acts on the drive magnet 722, causing the drive gear 710 to rotate. In one embodiment, the drive gear 710 is mechanically connected to the activation gear 706 such that as the impeller 718 rotates, the drive gear 710 engages the activation gear 706 to rotate the activation knob to the off position. In one embodiment, the activation gear 706 is geared down as compared to the impeller 718 and/or the drive gear 710.

Accordingly, when the specified volume of fluid has travelled through the volume control unit 312 and the activation knob 702 is positioned in the off position, the magnet 708 in the activation knob 702 (or coupled to the activation knob 702) is positioned above the lever magnet 712 to dispose the lever 714 in an up position to close the valve and prevent fluid flow through the volume control unit 312 (e.g., as described above with reference to FIGS. 1A-D). In this manner, the volume control unit 312 will run until a specified or desired volume or amount of fluid flows through the volume control unit 312.

In one embodiment, no penetrations are made to carry the shaft 720 up to turn the gears, but instead magnetic force is used to connect the gears under the activation knob 702 to the movement of the impeller 718. In one embodiment, this reduces the likelihood of leak issues as opposed to penetrations and sealing around a shaft.

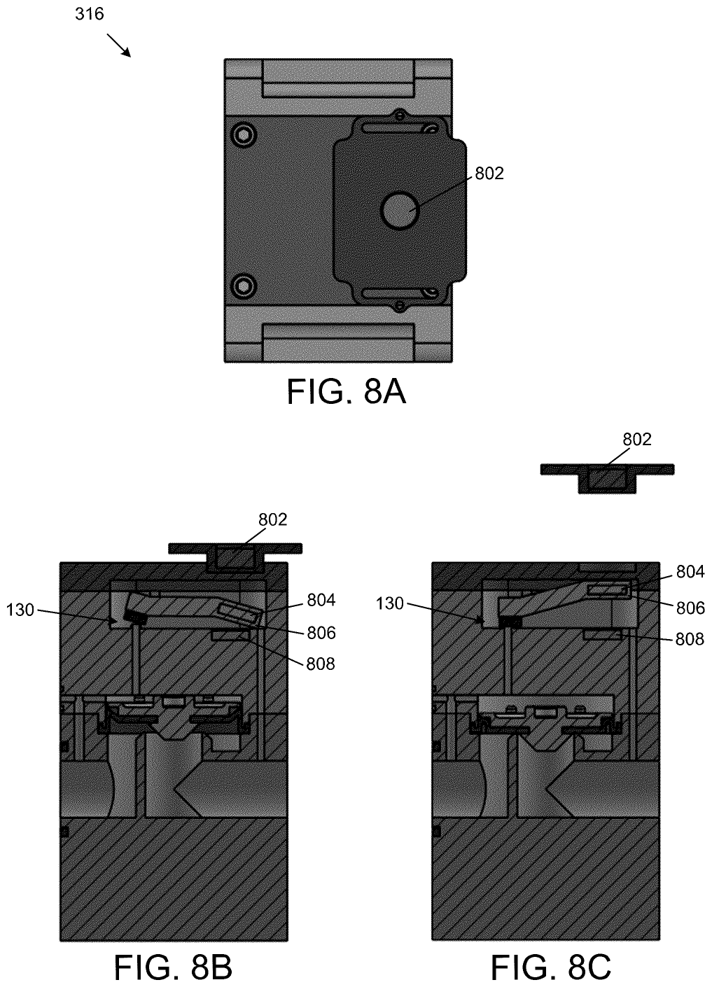

FIGS. 8A-8C show one embodiment of various stages of a magnetic control unit 316. In one embodiment, the magnetic control unit 316 is configured to control fluid flow through the magnetic control unit 316 based on magnetic interaction with an external magnet 802. FIG. 8A depicts one embodiment of an external magnet 802 placed on a surface of the magnetic control unit 316.

As shown in FIG. 8B, when the external magnet 802 is placed on a surface of the magnetic control unit 316, a lever magnet 804 within the lever 806 of a magnetic flow control component 130 is magnetically repelled by the external magnet 802 to dispose the lever 806 in the down position and open the valve to allow fluid flow through the magnetic control unit 316 (e.g., as described above with reference to FIGS. 1A-D).

As shown in FIG. 8C, when the external magnet 802 is removed from the surface of the magnetic control unit 316, the lever magnet 804 may be repelled by a bias magnet 808 to force the lever 806 to an up position to close the valve and prevent fluid flow through the magnetic control unit 316 (e.g., as described above with reference to FIGS. 1A-D). Accordingly, an external magnet 802 may be placed on various items to easily activate and deactivate the magnetic control unit 316 to allow and prevent fluid flow such as on a bracelet, bucket, water dish, or the like.

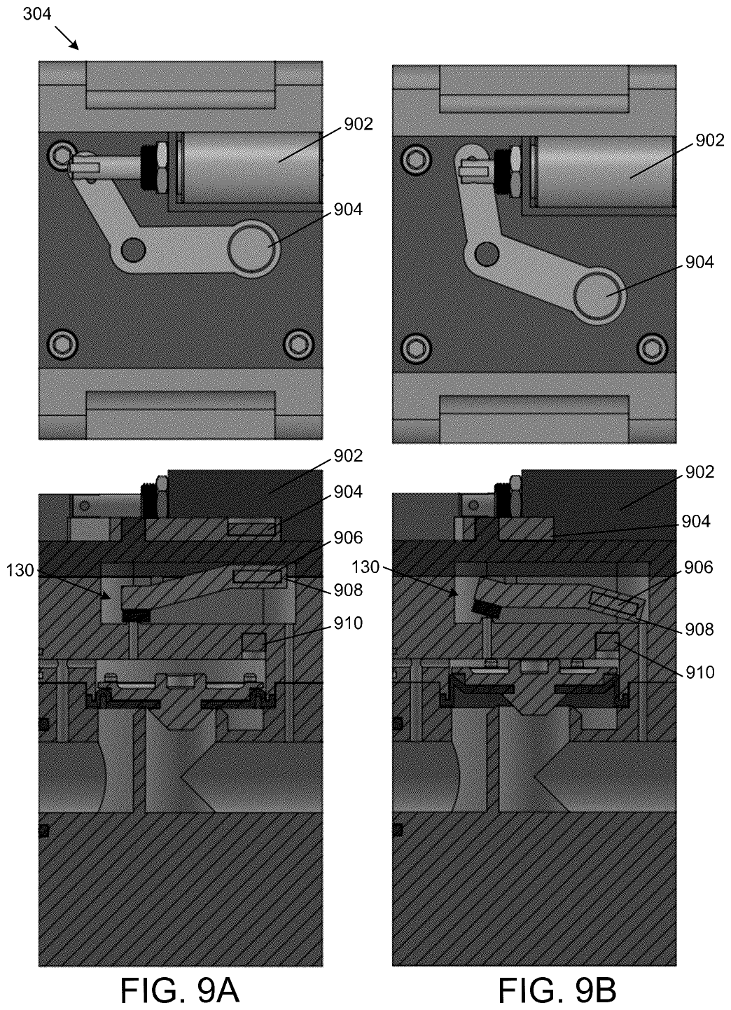

FIGS. 9A-9B show one embodiment of various stages of an electric control unit 304. In one embodiment, the electric control unit 304 includes an electrically-powered component 902 or motor to position an external magnet 904 to activate or deactivate the electric control unit 304 to allow or prevent fluid flow through the electric control unit 304. In one embodiment, the electrically-powered component 902 includes an electric solenoid, an electromagnet, or the like.

As shown in FIG. 9A, in one embodiment, when the electrically-powered component 902 is not activated, the external battery 904 is positioned proximate to a lever magnet 906 of a lever 908 of a magnetic flow control component 130 to magnetically attract the lever magnet 906 and dispose the lever 908 in an up position, which closes the valve and prevents fluid flow through the electric control unit 304 (e.g., as described above with reference to FIGS. 1A-D).

As shown in FIG. 9B, in one embodiment, when the electrically-powered component 902 is activated, the external battery 904 is positioned away from the lever magnet 906 of the lever 908 of a magnetic flow control component 130, which causes the lever 908 to be disposed in a down position in response to magnetic attraction between the lever magnet 906 and the bias magnet 910, which opens the valve and allows fluid flow through the electric control unit 304 (e.g., as described above with reference to FIGS. 1A-D).

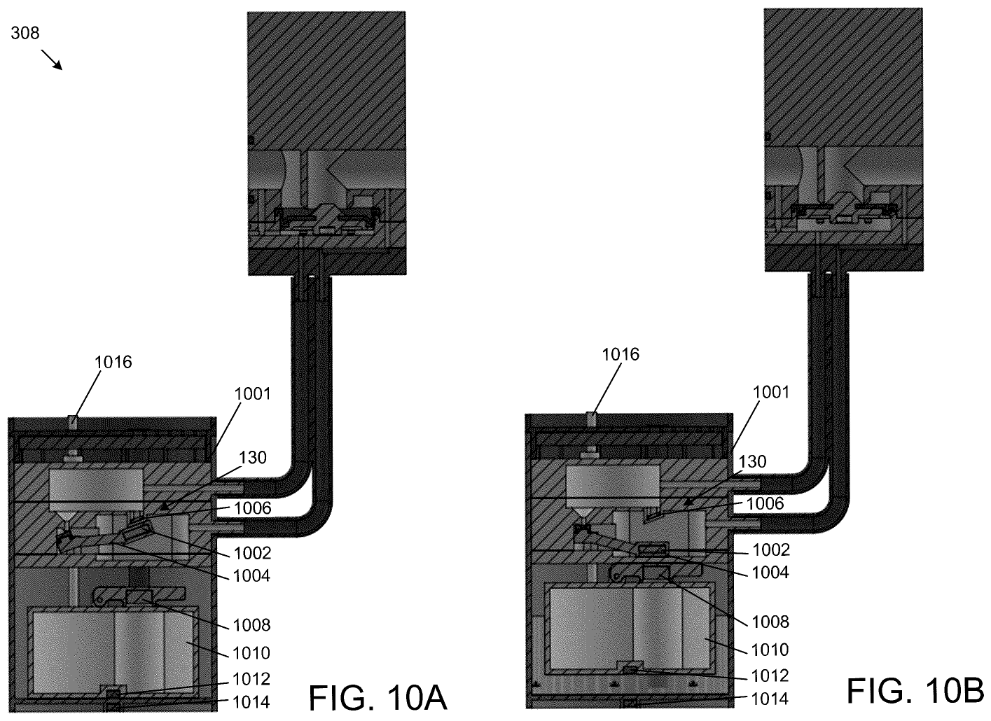

FIGS. 10A-10B show one embodiment of various stages of another leak detection control unit 308. In one embodiment, the leak detection control unit 308 is substantially similar to the valve device described in U.S. patent application Ser. No. 18/474,181 entitled VALVE and filed on Sep. 25, 2023, for Justin Sitz, which is incorporated herein by reference in its entirety. In one embodiment, the leak detection control unit 308 includes a container 1001, which is external to the valve, that includes a magnetic flow control component 130 and a magnetic float 1010. In general, the leak detection control unit 308 is configured to shut off fluid flow through the leak detection control unit 308 in response to detecting a leak such as a water leak. Accordingly, the containers 1001 may be placed where leaks are common such as in the floor of a laundry room, kitchen, bathroom, or the like, and multiple containers 1001 may be placed in series (e.g., connect containers 1001 in the kitchen, bathroom, utility room, laundry room, or the like) to prevent fluid flow in the event of a leak.

As shown in FIG. 10A, in one embodiment, the lever magnet 1002 is magnetically attracted to the bias magnet 1006 to position the lever 1004 in an up position to open the valve and allow fluid through the leak detection control unit 308 (e.g., as described above with reference to FIGS. 1A-D). Further, the magnetic float 1010 is located in the bottom of the container 1001 because there is no fluid in the container 1001. The magnetic float 1010 may further be biased towards the bottom on the container 1001 based on magnetic attraction between bias magnets 1012, 1014.

As shown in FIG. 10B, in one embodiment, as fluid begins to fill the container 1001, e.g., via an opening 1016 in the top of the container, the magnetic attraction between the bias magnets 1012, 1014 is overcome and the float moves to the top of the container 1001. In one embodiment, magnetic attraction between the float magnet 1008 and the lever magnet 1004 causes the lever 1004 to move to a down position, closing the valve and preventing fluid flow through the leak detection control unit 308 (e.g., as described above with reference to FIGS. 1A-D).

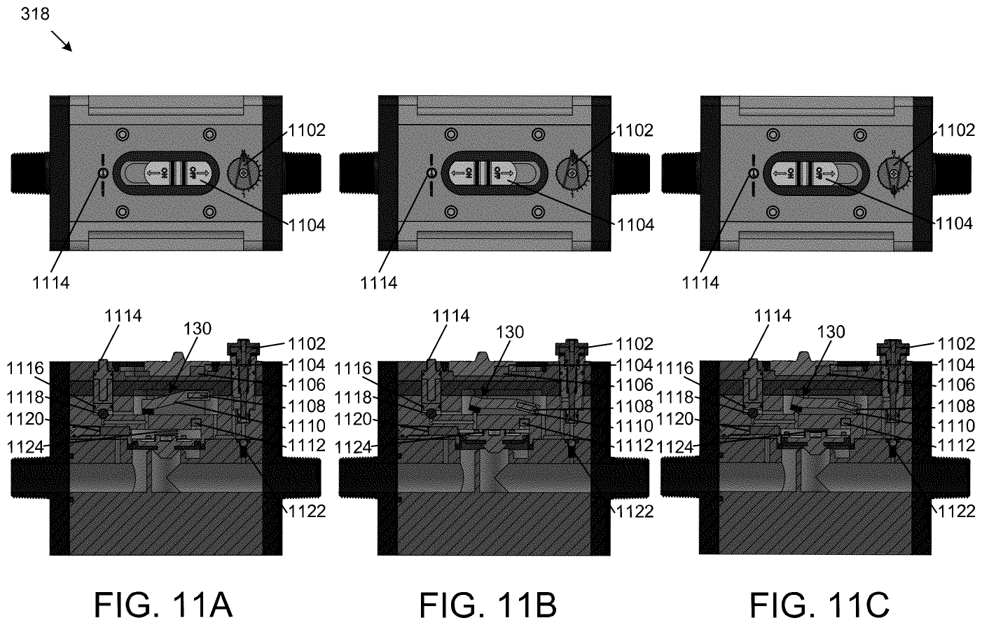

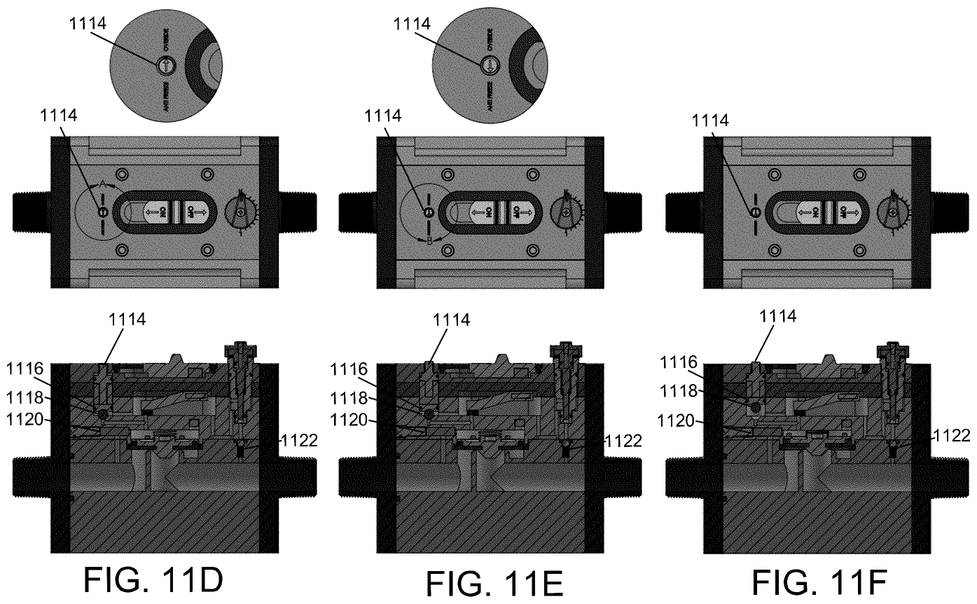

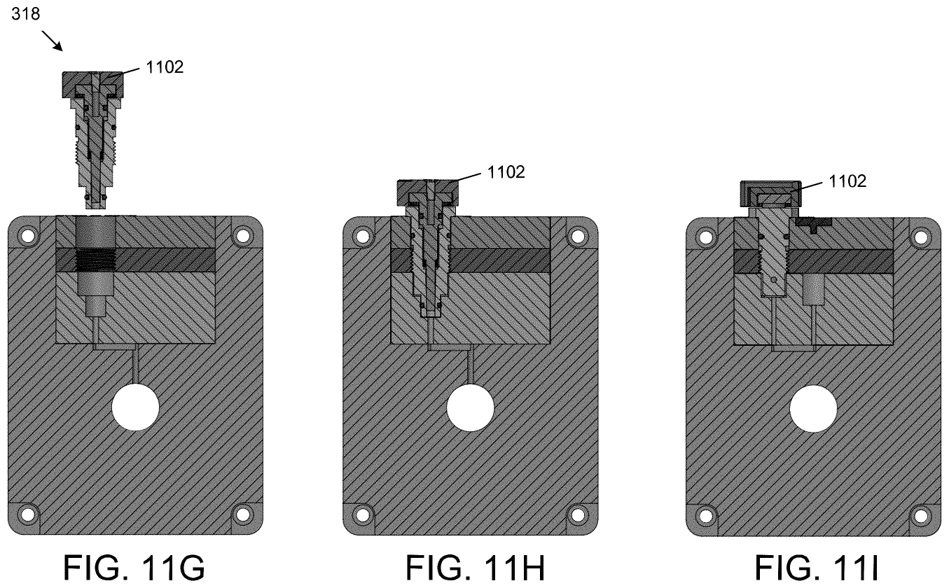

FIGS. 11A-11C show one embodiment of various stages of a flow control unit 318. In one embodiment, the flow control unit 318 is configured to regulate a rate of fluid flow through the valve device 300. In one embodiment, the flow control unit 318 includes a magnetic activation switch 1104 that is actionable to allow or prevent fluid flow through the flow control unit 318 (e.g., as described above with reference to FIGS. 1A-D).

As shown in FIG. 11A, in one embodiment, the magnetic activation switch 1104 includes a switch magnet 1006 that, when positioned or aligned with the lever magnet 1108, e.g., when moved to an off position, magnetically attracts the lever magnet 1108 to position the lever 1110 in an up position, which closes the valve of the flow control unit 318 to prevent fluid flow through the flow control unit 318 (e.g., as described above with reference to FIGS. 1A-D).

As shown in FIG. 11B, in one embodiment, when the magnetic activation switch 1104 is moved to an on position, the switch magnet 1106 is moved away from the lever magnet 1108, breaking magnetic attraction between the switch magnet 1106 and the lever magnet 1108, which causes the lever 1110 to be biased in a down position, at least in part due to magnetic attraction between the lever magnet 1108 and the bias magnet 1112, which opens the valve of the flow control unit 318 to allow fluid flow through the flow control unit 318 (e.g., as described above with reference to FIGS. 1A-D).

In one embodiment, the flow control unit 318 includes a flow control mechanism or knob 1102 that can be set at one of a plurality of flow settings to control the rate of fluid flow through the flow control unit 318 and the valve device 300 generally, e.g., when the activation switch 1104 is at an on position. In one embodiment, the flow control knob 1102 is substantially similar to the adjustable flow control knob 116 described above.

As shown in FIG. 11C, in one embodiment, the flow control knob 1102 is rotated to control a rate at which fluid flows through the flow control unit 318. In such an embodiment, the flow control knob 1102 may be set at one of a plurality of settings to control the flow rate, e.g., to allow full flow rate, no flow, or various flow rates in between. In such an embodiment, the flow control knob 1102 may act on the valve of the flow control unit 318, e.g., on the diaphragm, by increasing or decreasing pressure, or otherwise influencing the valve to increase or decrease the flow rate. In one embodiment, when placed in series with a different control units 302-318, the flow control unit 318 can control fluid flow through the valve device 300.

In one embodiment, the magnetic flow control component 130 includes a spring 1124 that helps assist the diaphragm to close when the fluid flow through the valve is turned off.

FIGS. 11D-11F shows various stages of the flow control unit 318 with an anti-freeze assembly. As used herein, the anti-freeze assembly is configured to allow for the release of an amount of fluid from the valve to prevent freezing and breaking of the valve. In one embodiment, the anti-freeze assembly includes a control dial 1114, a control plate 1116, a and a control ball 1118.

As shown in FIG. 11D, in one embodiment, the control dial 1114 is turned to an override setting, which overrides the anti-freeze mechanism and prevents fluid from being released to prevent freezing. In such an embodiment, with the control dial 1114 in the override position, the control dial 1114 screwed or inserted into the anti-freeze assembly, e.g., into a (metal) sleeve, putting pressure on the control plate 1116 and the control ball 1118, prevent fluid to enter the anti-freeze assembly.

As shown in FIG. 11E, in one embodiment, the control dial 1114 is rotated to the anti-freeze setting, which releases pressure on the control plate 1116 and the control ball 1118 such that fluid can enter the anti-freeze assembly and travel to the flow control device 1102 and out the outlet. In such an embodiment, pressure may be applied to the control ball 1118 by control plate 1116, which is encased in a sleeve filled with a temperature sensitive material such as thermal wax.

As shown in FIG. 11F, in one embodiment, upon freezing temperatures, the fluid enters the anti-freeze assembly from the main inlet and travels through the valve chamber and into the flow control assembly, where it is ultimately released out of main outlet. In one embodiment, upon freezing temperatures (e.g., 32 degrees F. or lower), the temperature sensitive material in the sleeve shrinks, relieving pressure on the control plate 1116 and the control ball 1118, which allows fluid to exit the valve.

In one embodiment, the flow control unit 318 includes a removeable filter 1120 for filtering out debris and other contaminants to keep the fluid lines free of obstructions. Further, in one embodiment, the flow control unit 318 includes a check valve 1122 that is configured to prevent backflow into the flow control knob assembly.

FIGS. 11G-11I show a sectional view of the flow control knob 1102. In one embodiment, the flow control knob 1102 is removeable from the flow control unit 318 to allow for cleaning, maintenance, repair, replacement, or the like. The flow control knob 1102, when installed, is rotatable to increase or decrease pressure on the valve, e.g., on the diaphragm, to control a rate at which fluid flows through the flow control unit 318 (e.g., as described above with reference to FIGS. 1A-D).

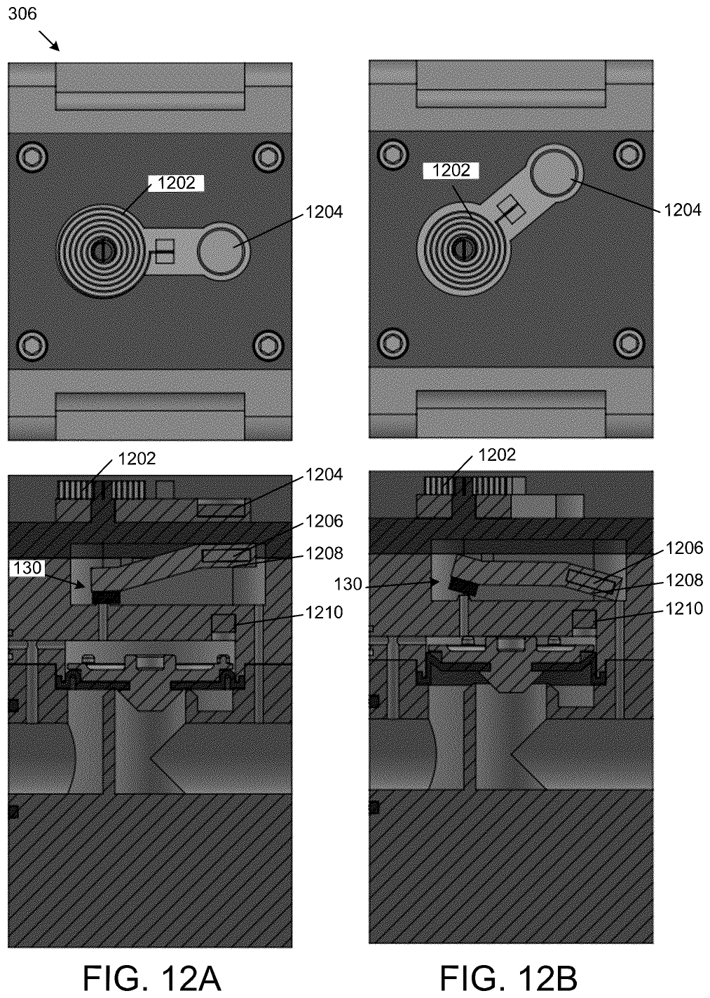

FIGS. 12A-12B show one embodiment of various stages of a temperature control unit 306. In one embodiment, the temperature control unit 306 is actuated to allow or prevent fluid flow through the temperature control unit 306 based on a temperature, e.g., an ambient temperature.

In one embodiment, the temperature control unit 306 includes a temperature sensitive mechanism 1202 that acts on an external magnet 1204. In one embodiment, the temperature sensitive mechanism 1202 includes a bi-metal spring or other material that expands and contracts as it interacts with changes in temperature. As used herein, a bi-metal spring may refer to a coil spring made of two different types of metals that are welded or fastened together. These metals could include copper, steel, or brass. The bi-metal spring may be used to convert a temperature change into mechanical displacement.

As shown in FIG. 12A, in one embodiment, at a first temperature or temperature range, the temperature sensitive mechanism 1202 may react to dispose the external magnet 1204 at a position or alignment with a lever magnet 1206 of a lever 1208 of a magnetic flow control component 130. In such an embodiment, the external magnet 1204 and the lever magnet 1206 magnetically attract to dispose the lever 1208 in an up position and close the valve to prevent fluid flow through the temperature control unit 306 (e.g., as described above with reference to FIGS. 1A-D).

As shown in FIG. 12B, in one embodiment, at a second temperature or temperature range, the temperature sensitive mechanism 1202 may react to dispose the external magnet 1204 at a position or alignment away from the lever magnet 1206 of the lever 1208 of the magnetic flow control component 130. In such an embodiment, the lever magnet 1206 and a bias magnet 1210 magnetically attract to dispose the lever 1208 in a down position and open the valve to allow fluid flow through the temperature control unit 306 (e.g., as described above with reference to FIGS. 1A-D).

As described above, in one embodiment, the various modular control units 302-318 can be combined in any configuration of type, number, position, or the like. Further, in one embodiment, the magnetic mechanism/action on the magnetic flow control component 130 could work in reverse, using repelling forces instead of attracting forces, and vice versa. Further, in one embodiment, one or more of the modular control units may include a flow control mechanism, e.g., as shown in FIGS. 11D-11F, to control the flow rate through each of the respective modular control units 302-318.

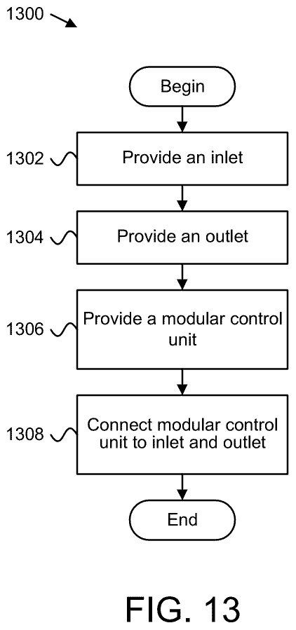

FIG. 13 is a flow chart diagram illustrating one embodiment of a method 1300 for a valve. In one embodiment, the method 1300 begins and provides 1302 an inlet, provides 1304 an outlet, provides 1306 at least one modular control unit, and connects 1308 the modular control unit to the inlet and the outlet, and the method 1300 ends.

In one embodiment, the modular control unit includes a valve and a magnetic flow control component that includes a lever, a first magnet disposed on or in the lever, and a second magnet disposed opposite the lever such that the lever is actuatable, via the first and second magnets, to open and close the valve to allow or prevent fluid flow through the apparatus from the inlet to the outlet.

In one embodiment, the at least one modular control unit controls fluid flow through the valve from the inlet to the outlet using the magnetic flow control component. Further, in one embodiment, the modular control unit is connectable to one or more additional modular control units to concurrently control the fluid flow from the inlet to the outlet.

It is noted that the modular control units may include various features of different modular control units. For example, each modular control unit may include a flow control assembly, an anti-freeze assembly, or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
an inlet;
an outlet;
a valve; and
a magnetic flow control component comprising:
an actuator;
a first magnet disposed on the actuator; and
a second magnet disposed opposite the actuator,
wherein the actuator is actuatable, via the first and second magnets, to open and close the valve to allow or prevent fluid flow through the apparatus from the inlet to the outlet.

2. The apparatus of claim 1, further comprising an adjustable flow control assembly for setting a flow rate of the fluid flow through the valve.

3. The apparatus of claim 1, further comprising an adjustable anti-freeze assembly for preventing fluid freezing in the valve.

4. The apparatus of claim 1, wherein the apparatus is a manual control unit that allows manual interaction with the magnetic flow control component to allow or prevent fluid flow through the valve.

5. The apparatus of claim 4, wherein the magnetic flow control component is actuated in response to a magnetic object being presented to the manual control unit to magnetically act on the first magnet to actuate the actuator to open or close the valve using a magnetic force.

6. The apparatus of claim 1, wherein the apparatus is an electric control unit comprising an electronic mechanism to allow or prevent fluid flow through the valve.

7. The apparatus of claim 6, wherein the magnetic flow control component is actuated in response to actuation of the electronic mechanism to position a third magnet to magnetically act on the first magnet to actuate the actuator to open or close the valve using a magnetic force.

8. The apparatus of claim 1, wherein the apparatus is a temperature control unit that is actuated to allow or prevent fluid flow through the valve based on a temperature.

9. The apparatus of claim 8, wherein the temperature control unit comprises a bi-metal spring that is configured to position a third magnet in response to a change in the temperature to magnetically act on the first magnet to actuate the actuator to open or close the valve using a magnetic force.

10. The apparatus of claim 1, wherein the apparatus is a leak detection control unit that controls fluid flow through the valve based on a volume of fluid collected from an external source.

11. The apparatus of claim 10, wherein the leak detection control unit comprises a separate container that is configured to hold the volume of fluid, the container comprising the magnetic flow control component and a magnetic float that comprises a third magnet that is configured to magnetically act on the first magnet based on the volume of the fluid within the container to actuate the actuator to open or close the valve using a magnetic force.

12. The apparatus of claim 1, wherein the apparatus is a leak detection control unit that controls fluid flow through the valve based on contact with a fluid from an external source.

13. The apparatus of claim 12, wherein the leak detection control unit comprises a magnetic activation actuator comprising a third magnet that is configured to magnetically act on the first magnet to control the fluid flow through the valve using a magnetic force, the magnetic activation actuator triggered in response to contacting the fluid from the external source.

14. The apparatus of claim 1, wherein the apparatus is a volume control unit that controls fluid flow through the valve based on a volume of fluid that has passed through the valve.

15. The apparatus of claim 14, wherein the volume control unit comprises an impeller that is configured to drive a third magnet of a magnetic control knob to a position to magnetically act on the first magnet to close the valve in response to an amount of fluid passing over the impeller satisfying the volume.

16. The apparatus of claim 1, wherein the apparatus is a timing control unit that controls fluid flow through the valve based on an amount of time.

17. The apparatus of claim 16, wherein the timing control unit comprises a timing control valve and a container for holding a volume of fluid, the volume of fluid in the container controllable by the timing control valve, the container comprising a magnetic float that includes a third magnet that is configured to magnetically act on the first magnet based on the volume of fluid in the container to control the fluid flow through the valve using a magnetic force.

18. The apparatus of claim 1, wherein the apparatus is a magnetic control unit that controls fluid flow through the valve based on magnetic interaction with an external third magnet, the external third magnet configured to magnetically act on the first magnet in response to being within magnetic proximity of the first magnet.

19. The apparatus of claim 1, wherein the apparatus is a flow control unit that is configured to regulate a rate of fluid flow through the valve, the flow control unit comprising a flow control mechanism that can be set at one of a plurality of flow settings to control the rate of fluid flow through the valve.

20. The apparatus of claim 19, wherein the flow control unit comprises a magnetic activation switch comprising a third magnet, the magnetic activation switch actionable to move the third magnet to magnetically act on the first magnet to allow or prevent fluid flow through the valve.

21. The apparatus of claim 1, wherein the apparatus is a modular control unit located between the inlet and the outlet and connecting the inlet to the outlet, the modular control unit controlling fluid flow through the valve from the inlet to the outlet using the magnetic flow control component, wherein the modular control unit is connectable to one or more additional modular control units to concurrently control the fluid flow from the inlet to the outlet.

22. The apparatus of claim 1, wherein the inlet and the outlet comprise modular end plates that are removably connected to apparatus.

23. A system, comprising:
an inlet;
an outlet;
a plurality of modular control units connected in series between the inlet and the outlet to concurrently control the fluid flow from the inlet to the outlet, each of the plurality of modular control units comprising:
a valve; and
a magnetic flow control component comprising:
a actuator;
a first magnet disposed on the actuator; and
a second magnet disposed opposite the actuator,
wherein the actuator is actuatable, via the first and second magnets, to open and close the valve to allow or prevent fluid flow through the apparatus from the inlet to the outlet.

24. A method, comprising:
providing an inlet;
providing an outlet;
providing at least one modular control unit, comprising:
a valve; and
a magnetic flow control component comprising:
a actuator;
a first magnet disposed on the actuator; and
a second magnet disposed opposite the actuator, wherein the actuator is actuatable, via the first and second magnets, to open and close the valve to allow or prevent fluid flow through the apparatus from the inlet to the outlet; and
connecting the at least one modular control unit to the inlet and the outlet, the at least one modular control unit controlling fluid flow through the valve from the inlet to the outlet using the magnetic flow control component, wherein the modular control unit is connectable to one or more additional modular control units to concurrently control the fluid flow from the inlet to the outlet.
